(19) United States
(12) Patent Application Publication
(10) Pub. No.: US 2008/0288992 A1
(43) Pub. Date: Nov. 20, 2008

(54) Systems and Methods for Improving Image Responsivity in a Multimedia Transmission System

(76) Inventors: Mohammad Usman, Mission Viejo, CA (US); Ammar ur Rahman Khan, Tustin, CA (US); Malik Muhammad Saqib, Irvine, CA (US); Asfandyar Khan, Tustin, CA (US); Charlie Raasch, Lake Forest, CA (US)

Correspondence Address: PATENTMETRIX, 14252 CULVER DR. BOX 914, IRVINE, CA, 92604, US

(21) Appl. No.: 12/101,851

(22) Filed: Apr. 11, 2008

Related U.S. Application Data
(60) Provisional application No. 60/911,109, filed on Apr. 11, 2007.

(51) Int. Cl. H04N 7/173; G09G 5/00

(52) U.S. Cl. 725/105; 345/632; 725/134

(57) ABSTRACT

The present invention relates to improved methods and systems for transmission of images overlaid on video, particularly images requiring high levels of responsivity (e.g. mouse pointers) relative to the underlying video, from a computing device to a television. In one embodiment, the present invention is directed to a method of transmitting at least one video frame with an overlaid image, comprising the steps of capturing at least one frame of video data separate from the overlaid image at a first rate, capturing the overlaid image separate from the frame of video data at a second rate, packetizing the captured frame of video data, packetizing the overlaid image, wherein the frame video data are in data packets separate from the overlaid image data packets, and transmitting separate video data packets and overlaid image data packets.

### CROSS REFERENCE TO PRIOR APPLICATION

The present invention relies on U.S. Provisional Patent Application No. 60/911,109, filed on Apr. 11, 2007, for priority.

### FIELD OF THE INVENTION

The present invention relates generally to methods and systems for the real time transmission of data from a source to a monitor. Specifically, the present invention relates to improved methods and systems for transmission of images overlaid on video, particularly images requiring high levels of responsivity (e.g. mouse pointers) relative to the underlying video, from a computing device to a television.

### BACKGROUND OF THE INVENTION

Individuals use their computing devices, including personal computers, storage devices, mobile phones, personal data assistants, and servers, to store, record, transmit, receive, and playback media, including, but not limited to, graphics, text, video, images, and audio. Such media may be obtained from many sources, including, but not limited to, the Internet, CDs, DVDs, other networks, or other storage devices. However, individuals are often forced to experience the obtained media on small screens that are not suitable for audiences in excess of one or two people.

Despite the rapid growth and flexibility of using computing devices to store, record, transmit, receive, and playback media, a vast majority of individuals throughout the world still use televisions as the primary means by which they receive audio/video transmissions. Specifically, over the air, satellite, and cable transmissions to televisions still represent the dominant means by which audio/video media is communicated to, and experienced by, individuals. Those transmissions, however, are highly restricted in terms of cost, range of content, access time and geography.

Given the ubiquity of individual computing devices being used to store, record, transmit, receive, and playback media, it would be preferred to be able to use those same computing devices, in conjunction with the vast installed base of televisions, to allow individuals to rapidly and flexibly obtain media and, yet, still use their televisions to experience the media.

Prior attempts at enabling the integration of computing devices with televisions have focused on a) transforming the television into a networked computing appliance that directly accesses the Internet to obtain media, b) creating a specialized hardware device that receives media from a computing device, stores it, and, through a wired connection, transfers it to the television, and/or c) integrating into the television a means to accept storage devices, such as memory sticks. However, these conventional approaches suffer from having to substantially modify existing equipment, i.e. replacing existing computing devices and/or televisions, or purchasing expensive new hardware. Additionally, both approaches have typically required the use of multiple physical hard-wired connections to transmit graphics, text, audio, and video.

Besides the aforementioned limitations, another hindrance to effortless integration of computing devices, particularly personal computers with televisions is presented by the difference between the refresh rate of a computer monitor and a television screen. A television display typically has a 30 frame per second refresh rate. When a computer is coupled to a television for displaying content on the television screen, the refresh rate of the transmitted video is of the order of 10 frames per second owing to bandwidth constraints. This difference in refresh rates is not significantly apparent when a viewer is simply watching the transmitted video. However, if the viewer wants to work with the personal computer using a mouse, the difference in refresh rates becomes a problem as it considerably reduces the responsiveness of the mouse. In particular, the mouse icon refresh rate can occur on the order of 60 frames per second.

There is therefore a need for methods, devices, and systems that enable individuals to use existing computing devices to receive, transmit, store, and playback media and to use existing televisions to experience the media in a simple and inexpensive manner. There is also a need for methods and systems to seamlessly integrate a computing device with a television, such that the television is transformed into a remote monitor while maintaining the responsiveness of input devices attached to the computing device. It would also be preferred if a system can be provided that would compensate between the existing video transmission frame rate and the desired responsivity rate of an image, namely a mouse pointer or icon. The responsivity rate is typically equal to the conventional refresh rate of a computer, such as 60 times per second.

### SUMMARY OF THE INVENTION

The present invention relates to improved methods and systems for transmission of images overlaid on video, particularly images requiring high levels of responsivity (e.g. mouse pointers) relative to the underlying video, from a computing device to a television. In one embodiment, the present invention is directed to a method of transmitting at least one video frame with an overlaid image, comprising the steps of capturing at least one frame of video data separate from the overlaid image at a first rate, capturing the overlaid image separate from the frame of video data at a second rate, packetizing the captured frame of video data, packetizing the overlaid image, wherein the frame video data are in data packets separate from the overlaid image data packets, and transmitting separate video data packets and overlaid image data packets. The overlaid image can be any type of image, including a mouse icon or other pointers. The first rate and second rate can be of any value, including where the first rate is equal to the second rate, where the first rate is less than the second rate, where the first rate is in the range of 10 to 30 times per second, and where the second rate is in the range of 30 to 60 times per second.

Optionally, the captured video data and captured overlaid image are compressed prior to transmission. A copy of the captured overlaid image is locally stored for use in a future transmission. The video data packets and overlaid image data packets are captured and transmitted in a first time period and a copy of the captured overlaid image captured from a time period prior to the first time period is transmitted with the video data packets and overlaid image data packets captured in the first time period.

In another embodiment, the present invention relates to a method of receiving at least one video frame and an overlaid image, comprising the steps of receiving a plurality of video data packets having video data, storing video data packets in a buffer array, receiving a plurality of overlaid image packets having overlaid image data, storing overlaid image packets in a memory, rendering video data with the overlaid image by accessing a first position in the buffer array, accessing a fifo device associated with the first position in the buffer array, and, based upon data in the fifo device, accessing a memory containing the overlaid image data. The overlaid image can be any type of image, including a mouse icon or other pointers.

Optionally, the plurality of overlaid image packets comprise overlaid image data to be rendered and overlaid image data to be erased. Accessing the memory containing the overlaid image data includes accessing overlaid image data to be rendered and overlaid image data to be erased. The method further comprises the step of accessing a second position in the buffer array, accessing a fifo device associated with the second position in the buffer array, and, based upon data in the fifo device, accessing the memory containing the overlaid image. Accessing the memory containing the overlaid image data includes accessing overlaid image data to be rendered and overlaid image data to be erased.

In another embodiment, the present invention relates to a method of transmitting and receiving at least one video frame with an overlaid image, comprising the steps of capturing said at least one frame of video data separate from said overlaid image at a first rate, capturing said overlaid image separate from said frame of video data at a second rate, packetizing said captured frame of video data, packetizing said overlaid image, wherein said frame video data are in data packets separate from said overlaid image data packets, transmitting said separate video data packets and overlaid image data packets, receiving said video data packets having video data, storing said video data packets in a buffer array, receiving said overlaid image packets having overlaid image data, storing said overlaid image packets in a memory, and rendering said video data with said overlaid image by accessing a first position in said buffer array, accessing a fifo device associated with said first position in said buffer array, and, based upon data in said fifo device, accessing said memory containing said overlaid image data.

### BRIEF DESCRIPTION OF THE DRAWINGS

These and other features and advantages of the present invention will be appreciated, as they become better understood by reference to the following Detailed Description when considered in connection with the accompanying drawings, wherein:

FIG. 1 depicts a block diagram of the integrated wireless media transmission system of the present invention;

FIG. 2 depicts the components of a transmitter of one embodiment of the present invention;

FIG. 3 depicts a plurality of software modules comprising one embodiment of a software implementation of the present invention;

FIG. 4 depicts the components of a receiver of one embodiment of the present invention;

FIG. 5 is a flowchart depicting the method of transmission of media, as used with the present invention;

FIG. 6 is a flowchart illustrating one method of synchronization of video and mouse signals;

FIG. 7 is a flowchart depicting exemplary functional steps of the TCP/UDP RT transmission protocol of the present invention; and

FIG. 8 is a schematic diagram depicting the communication between a transmitter and plurality of receiving display devices.

### DETAILED DESCRIPTION

The present invention is an integrated wireless system for transmitting media from one device to another device in real time. The present invention will be described with reference to the aforementioned drawings. The embodiments described herein are not intended to be exhaustive or to limit the invention to the precise forms disclosed. They are chosen to explain the invention and its application and to enable others skilled in the art to utilize the invention. In particular, the present invention is described in relation to wireless transmission methods using specific transmission protocols. However, the present invention is not limited to wireless transmission and can include wired transmission. Further, the present invention is not limited to a specific transmission protocol and can encompass any protocol, including TCP/IP.

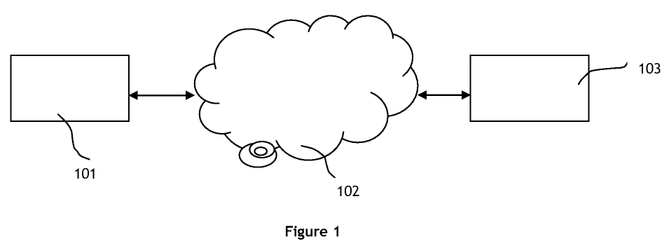

Referring to FIG. 1, a computing device 101, such as a conventional personal computer, desktop, laptop, PDA, gaming console, or any other device, operating the novel systems of the present invention communicates through a wireless network 102 to a remote monitor 103. Preferably, the computing device 101 and remote monitor 103 further comprise a processing system on a chip capable of wirelessly transmitting and receiving graphics, audio, text, and video encoded under a plurality of standards. The remote monitor 103 can be a television, plasma display device, flat panel LCD, HDD, projector or any other electronic display device known in the art capable of visually rendering graphics, audio and video. The processing system on chip can either be integrated into the remote monitor 103 and computing device 101 or incorporated into a standalone device that is in wired communication with the remote monitor 103 or computing device 101. An exemplary processing system on a chip is described in PCT/US2006/00622, which is also assigned to the owner of the present application, and incorporated herein by reference.

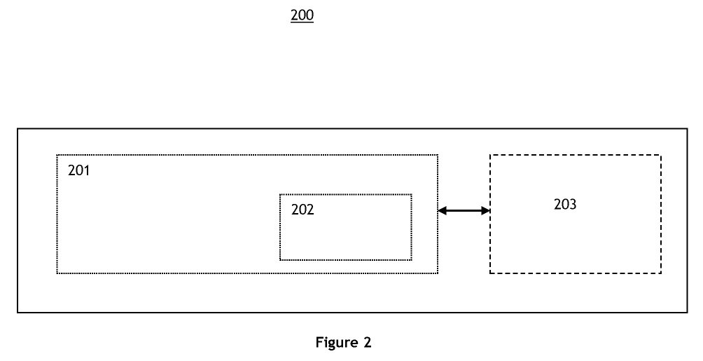

Referring to FIG. 2, a computing device 200 of the present invention is depicted. Computing device 200 comprises an operating system 201 capable running the novel software systems of the present invention 202 and a transceiver 203. The operating system 201 can be any operating system including but not limited to MS Windows 2000™, MS Windows NT™, MS Windows XP™, Windows Vista™, Linux, OS/2™, Palm™-based operating systems, cell phone operating systems, iPod™ operating systems, and MAC OS™. The computing device 200 transmits media using appropriate wireless standards for the transmission of graphics, text, video and audio signals, for example, IEEE 802.11a, 802.11g, Bluetooth2.0, HomeRF 2.0, HiperLAN/2, and Ultra Wideband, among others, along with proprietary extensions to any of these standards. Alternatively, the computing device 200 transmits media through a wired connection.

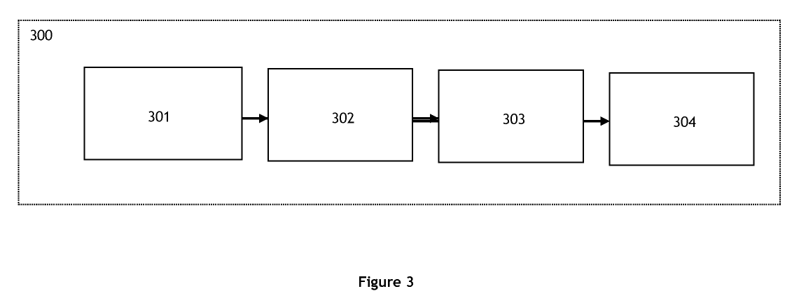

Referring to FIG. 3, modules of the novel software system 300 of the present invention are depicted. The software 300 comprises a module for the real-time capture of media 301, a module for managing a buffer for storing the captured media 302, a codec 303 for compressing and decompressing the media, and a module for packaging the processed media for transmission 304. In one embodiment, the computing device receives media from a source, whether it be downloaded from the Internet, real-time streamed from the Internet, transmitted from a cable or satellite station, transferred from a storage device, or any other source. The media is played on the computing device via suitable player installed on the computing device. While the media is played on the computing device, the software module 301 captures the data in real time and temporarily stores it in the buffer 302 before transmitting it to the CODEC. One of ordinary skill in the art would appreciate how to capture a video frame separate from a data block representative of a particular image, such as a mouse icon. Many operating systems, including Microsoft windows, permits such selective video and image capturing. In one embodiment, module 301 captures the video (data frame) without the overlaid image (mouse pointer).

The CODEC 303 compresses the captured data separately and prepares the data for transmission. Module 304 packages the video and mouse signals into separate packets before transmission. The separately captured and compressed mouse data packet and video data packet each comprise distinct headers to identify the packets as being mouse data and video data respectively. Concurrently, the mouse data packet is also stored and categorized as an erase packet, for later use. The erase packet is transmitted whenever a new mouse packet is sent and the previous mouse data needs to be erased. The mouse packet can be captured, compressed, and stored at a higher frequency rate than the capturing, compression, and storage of a video frame. As such, while a mouse and video frame may only be concurrently captured and transmitted at times t₀, t₃₀ and t₆₀, a mouse packet can be captured at t₀, t₁, t₂, t₃, t₄, t₅, through to t₆₀. Each time a mouse packet is captured and transmitted (at time tᵢ), an erase packet equal to the mouse packet from the prior time period, which was previously captured and stored as described above, is concurrently transmitted (at time tᵢ₋₁).

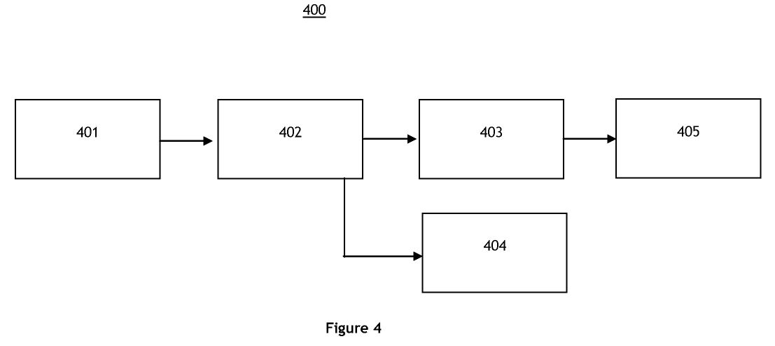

Referring to FIG. 4, a receiver of the present invention is depicted. The receiver 400 comprises a transceiver 401, a CODEC 402, a first memory and second memory with an associated fifo 403, a display device 405 for rendering video, image and graphics data, and an audio device 404 for rendering the audio data.

The transceiver 401 receives the compressed media data, preferably through a transmission protocol described below. It should be appreciated, however, that any transmission protocol can be used, including TCP/IP. In one example, the transmission protocol is a TCP/UDP hybrid protocol. The TCP/UDP hybrid protocol for the real-time transmission of packets combines the security services of TCP with the simplicity and lower processing requirements of UDP.

At the receiver, video or graphics packets are received followed by, or preceded by, the mouse (image) packets. The content received by the receiver is then transmitted to the CODEC 402 for decompression. The CODEC decompresses the media and prepares the video, mouse and audio signals, which are then stored in memory. Referring to block 403, video data is stored in a first memory, which can be any form of local memory including buffer or cache memory. More specifically, in one embodiment, when a frame of video data is received and decompressed, it is placed in a first memory location in a buffer array. The associated mouse packets are placed in a second memory space, not necessarily located within, or part of, the video data buffer array. A fifo device, associated with the first memory location of the video data buffer array, tracks the location of the stored mouse packets. Subsequently received video data frames are received, compressed, and placed in other spaces within the buffer array. Each memory location in the video data buffer array has an associated fifo device that maps to a location of stored mouse packets.

In operation, the display device 405 accesses the first memory location in the video data buffer array. The display device 405 is further instructed to concurrently access the fifo device which points to a memory location containing at least one packet containing image data and, optionally, one packet containing image data designated as an erase packet. The display device 405 renders the video data in the first memory location and uses the mouse packets to erase a prior mouse image and render a new mouse image. Where the display device 405 subsequently accesses a memory location in the video data buffer array which does not have any data, or any new data, the display device 405 concurrently accesses the fifo device which points to a memory location containing at least one packet containing image data and, optionally, one packet containing image data designated as an erase packet. As previously discussed, these mouse/image packets may be transmitted and received, even where no new video data has been transmitted and received. The display device 405 uses the mouse packets to erase a prior mouse image and render a new mouse image over the same video data frame. In this manner, the mouse (or other image) data can be rapidly updated even if no new video data has been received.

It should be appreciated that, rather than receive an erase packet from the transmitter, the receiver can be programmed to independently store a copy of previously received mouse/image packets and use the mouse/image packet from the immediately prior time period to erase the overlaid mouse/image. This would relieve the transmitter from having to store and transmit a mouse/image packet copy.

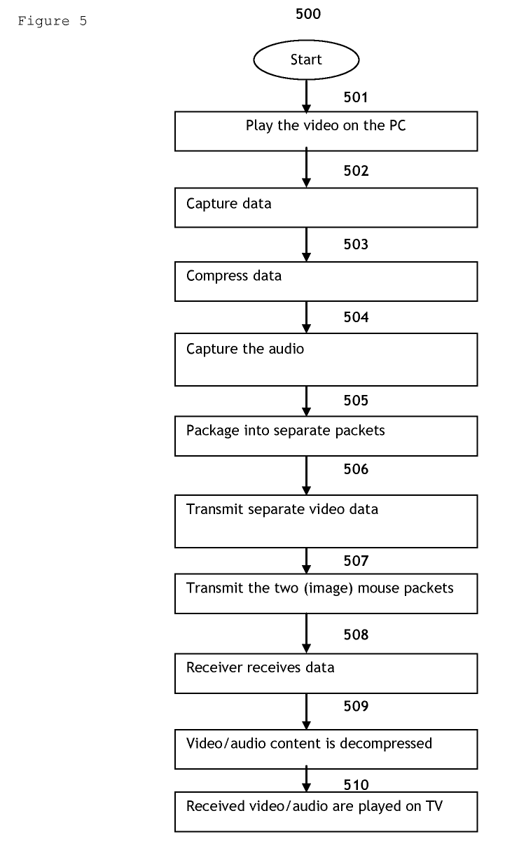

Referring to FIG. 5, a flowchart 500 depicts an exemplary operation of the integrated wireless system of the present invention. The personal computer plays 501 the media using appropriate media player on its console. Such media player can include players from Apple™ (iPod™), RealNetworks™ (RealPlayer™), Microsoft™ (Windows Media Player™), or any other media player. The software of the present invention captures 502 the real time video and overlaid image from the appropriate buffers. The captured data is then compressed 503 using the CODEC. Similarly, the audio is captured 504 using the audio software operating on the computing device and is compressed using the CODEC.

The media is then transmitted simultaneously in a synchronized manner wirelessly to a receiver. As mentioned previously, the video and mouse packets are packaged separately prior to transmission. This is depicted through step 505. During transmission, the video frame is transmitted first, without the overlaid mouse packet. This is shown in step 506. The audio signal is also transmitted in synchronization with the video signal. In times of constrained bandwidth, the transmission rate of video/audio data is on the order of 10-20 frames per second (fps).

In the next step 507, two mouse packets are transmitted. The first mouse packet, captured from a prior time period, comprises data that can be used to erase the prior mouse image that has been overlaid on the video frame at the receiver side. Thus, when rendered again, the underlying video/graphics frame is shown without the overlaid mouse image. The second mouse packet comprises the current mouse image. This new mouse image information is overlaid on the video or graphics frame transmitted earlier. In one embodiment, the mouse packets data is in 32×32 or 64×64 pixel format.

It should be appreciated that the mouse packet transmission can adopt different configurations and arrangements. For example, video packets can be broken down into numerous subunits and the mouse packets can be sent in conjunction with or between any video packet subunit. Because the mouse packets are transmitted on a different channel than the video packets, they can be inserted at any time and synchronized with video frames. Preferably, the mouse (image) icons are transmitted at a rate equal to the computer refresh rate while the video frame rate is transmitted at a rate permitted by bandwidth, preferably in the range of 10 to 30 frames per second.

This method of transmission yields a video/graphics transmission of 10 fps-30 fps and a mouse transmission that is a higher frame per second, such as 60 fps. It should be appreciated that by separating out the packets in this manner, one can adjust the video/graphics frame rate separately from the mouse image frame rate, thereby making the video/graphics frame rate lower and the mouse image frame rate higher. With the transmission method of the present invention, the achieved effective mouse transmission rate of 60 fps or greater overcomes the conventional problem of having a mouse pointer refresh rate tied to the rate of video/graphics rendering and significantly improves the mouse responsiveness. It should further be appreciated that one objective is to match the mouse refresh rate with a monitor refresh rate, which, while typically at 60 fps, can be at any other refresh rate.

It should be appreciated that, while the described embodiment is directed to improving the responsiveness of the mouse pointer, it can be applied to any rendered data. Specifically, wherever there is a need for a particular image, or rendered piece of data, to be more responsive to user interaction than other data, such as video, on which that more responsive image is overlaid or associated, the image can be made more responsive by separating it from the other data and, at the desired frame rate, transmitting image overlay packets and erase packets. Therefore, this technique can work for any type of pointer, in any iconic format, representing any peripheral device. It can also work for pop-up graphical images or other graphics that appear with any periodicity and require improved responsiveness. It can be applied to any two sets of data, such as images, icons, video, audio, or other data, that have differing preferred transmission rates.

The compressed media data which is transmitted in packets as mentioned above is received 508 at the receiver, which is in data communication with the remote monitoring device. The media data is then uncompressed 509 using the CODEC. The data is then finally rendered 510 on the television or other display device.

Referring back to module 301 in FIG. 3, media capture in the computing device is carried out through the implementation of software modules comprising a mirror display driver and a virtual display driver. In one embodiment, the mirror display driver and virtual display driver are installed as components in the kernel mode of the operating system running on the computer that hosts the software of the present invention. In one embodiment, the mirror display driver and virtual display driver operate in the kernel space of a Microsoft operating system, such as a Windows 2000/NT™ compatible operating system.

A mirror display driver for a virtual device mirrors the operation of a physical display device driver by mirroring the operations of the physical display device driver. In one embodiment, a mirror display driver is used for capturing the contents of a primary display associated with the computer while a virtual display driver is used to capture the contents of an “extended desktop” or a secondary display device associated with the computer.

In use, the operating system renders graphics and video content onto the video memory of a virtual display driver and a mirror display driver. Therefore, any media being played by the computer using, for example, a media player is also rendered on one of these drivers. An application component of the software of the present invention maps the video memory of virtual display driver and mirror display driver in the application space. In this manner, the application of the present invention obtains a pointer to the video memory and captures the real-time images projected on the display (and, therefore, the real-time graphics or video content that is being displayed) by copying the memory from the mapped video memory to locally allocated memory.

In one embodiment, a software library is used to support the capturing of a computer display using the mirror or virtual device drivers. The library maps the video memory allocated in the mirror and virtual device drivers in the application space when it is initialized. In the capture function, the library copies the mapped video buffer in the application buffer. In this manner, the application has a copy of the computer display at that particular instance.

For capturing the image which is overlaid on the video, the library maps the video buffer in the application space. In addition, a pointer is also mapped in the application space which holds the address of the overlay surface that was last rendered, that is the previous location of the mouse. This pointer is updated in the driver. The library obtains a notification from the virtual display driver when rendering on the overlay memory starts. The display driver informs the capture library of the color key value. The color key value is a special value which is pasted on the main video memory by the Graphics Display Interface to represent the region on which the data rendered on the overlay should be copied. After copying the main video memory, a software module copies the last image using the pointer which was mapped from the driver space. Since by default rendering on the overlay surface is done in YUV 420 format, therefore the software module performs the YUV to RGB conversion and pastes the RGB data, after stretching to the required dimensions, on the rectangular area of the main video memory where the color key value is present. The YUV to RGB conversion and subsequent processing enables image co-ordinates to be captured and transmitted to the receiver and be displayed along with the video on a remote display such as a television.

In one embodiment of the system of present invention, the video signal at the receiver end is substantially synchronized with the mouse signal. This implies that while there may be a slight, theoretically measurable difference between the presentation of the video data and the presentation of the corresponding mouse location, such a small difference in the presentation of the mouse and video data is not likely to be perceived by a user watching the presented media data.

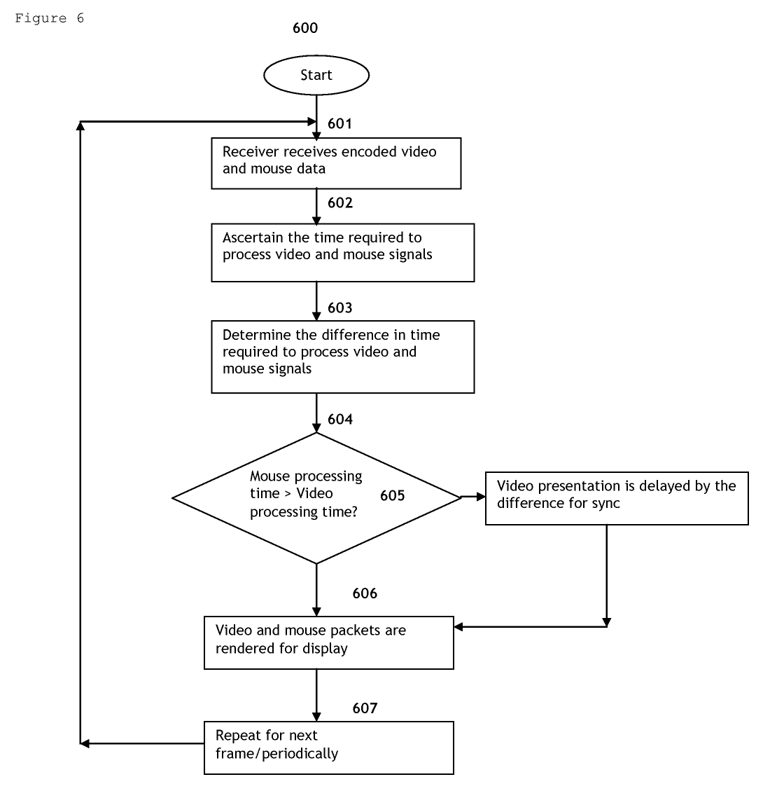

Referring to FIG. 6, a flowchart 600 depicts one embodiment of synchronizing video and mouse signals of the integrated multimedia system of the present invention. Initially, the receiver receives 601 a stream of encoded video and mouse data. The receiver then ascertains 602 the time required to process the video portion and the mouse portion of the encoded stream. Subsequently, the receiver determines 603 the difference in time to process the video portion of the encoded stream as compared to the mouse portion of the encoded stream. From this the receiver establishes 604 which of the two—video packet processing time or the mouse packet processing time—is greater.

If the mouse packet processing time is greater, the video presentation is delayed 605 by the difference determined, thereby synchronizing the decoded video data with the decoded mouse co-ordinate data. In this manner the video and mouse signals are synchronized and rendered 606 on the display.

A typical transport stream is received at a substantially constant rate. In this situation, the delay that is applied to the video presentation is not likely to change frequently. Thus, the aforementioned procedure may be performed periodically (e.g., every few seconds or every 30 received video frames) to be sure that the delay currently being applied to the video presentation is still within a particular threshold, that is, the delay is not visually perceptible. Alternatively, the procedure may be performed for each new frame of video data received from the transport stream. This is depicted in step 607.

In one embodiment of the present invention, audio capture is carried out through an interface used by conventional computer-based audio players to play audio data. In one embodiment, audio is captured using Microsoft Windows Multimedia API™, which is a software module compatible with Microsoft Windows™ and NT™ operating systems. A Microsoft Windows™ Multimedia Library provides an interface to the applications to play as well as record audio data. The applications can specify the format (sampling frequency, bits per sample) in which it wants to record the data.

To transmit the media, any transmission protocol may be employed. In the present embodiment, video and audio data streams are transmitted separately, but are synchronized using a clock or counter in accordance with a hybrid TCP/UDP protocol. A clock or a counter sequence is used to provide a reference against which each data stream is timed.

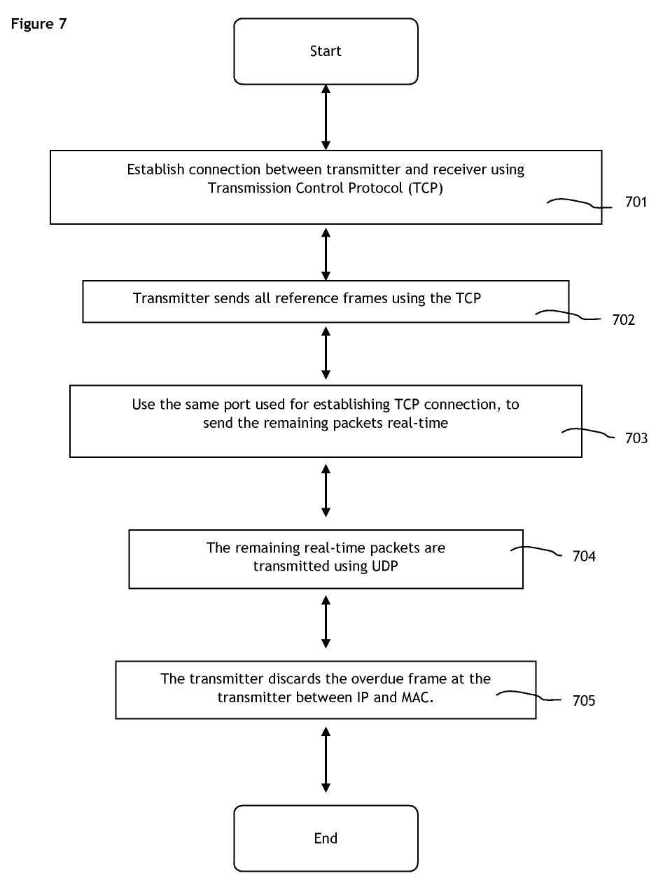

FIG. 7 is a flow diagram that depicts the functional steps of the TCP/UDP real-time (RT) transmission protocol implemented in the present invention. The transmitter and receiver, as previously described, establish 701 connection using TCP and the transmitter sends 702 all the reference frames using TCP. Thereafter, the transmitter uses 703 the same TCP port, which was used to establish connection in step 701, to send rest of the real-time packets but switches 704 to the UDP as transport protocol. While transmitting real-time packets using UDP, the transmitter further checks for the presence of an RT packet that is overdue for transmission. The transmitter discards 705 the overdue frame at the transmitter itself between IP and MAC. However an overdue reference frame/packet is always sent. Thus, the TCP/UDP protocol significantly reduces collisions while substantially improving the performance of RT traffic and network throughput.

The TCP/UDP protocol is additionally adapted to use ACK spoofing as a congestion-signaling method for RT transmission over wireless networks. With ACK spoofing, if the receiver does not receive any ACK within a certain period of time, the transmitter generates a false ACK for the TCP, so that it resumes the sending process. This improves the speed of RT traffic. In an alternate embodiment, in the event of poor quality of transmission due to congestion and reduced network throughput, the connection between the transmitter and receiver is broken and a new TCP connection is opened to the same receiver. This results in clearing congestion problems associated with the previous connection. It should be appreciated that this transmission method is just one of several transmission methods that could be used and is intended to describe an exemplary operation.

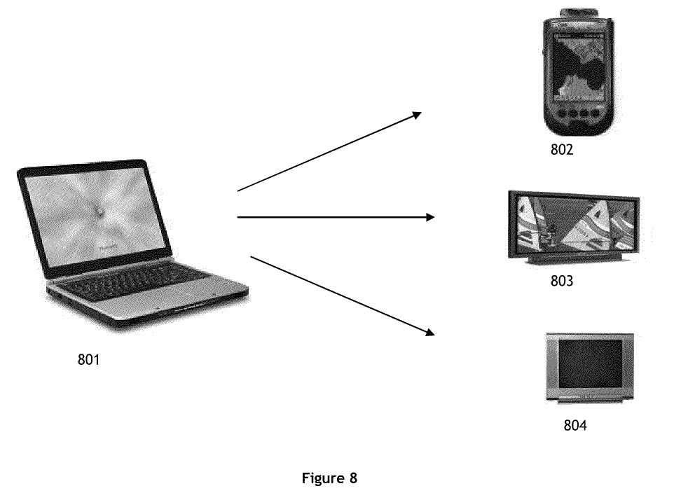

In an exemplary application, the present invention enables the real-time transmission of media from a computing device to one or more remote monitoring devices or other computing devices. Referring to FIG. 8, another arrangement of the integrated wireless multimedia system of the present invention is depicted. In this particular embodiment the communication between the transmitter 801 and a plurality of receivers 802, 803, 804 is depicted. The transmitter 801 wirelessly transmits the media to a receiver integrated into, or in data communication with, multiple display devices 801, 802, and 803 for real-time rendering. In each of these multiple devices, mouse signals are received in synchronization with video signals, such that the viewer experiences substantially real time response on all the display devices while interacting with the mouse.

In another application the software of the present invention is used in both the mirror capture mode and the extended mode. In mirror capture mode, the real time streaming of the content takes place with the identical content being displayed both at the transmitter and the receiver end. However, in an extended mode, a user can work on some other application at the transmitter side and the transmission can continue as a backend process. In either case, mouse responsiveness on the receiver side is experienced without any perceptible lag.

The above examples are merely illustrative of the many applications of the system of present invention. Although only a few embodiments of the present invention have been described herein, it should be understood that the present invention might be embodied in many other specific forms without departing from the spirit or scope of the invention. For example, other configurations of transmitter, network and receiver could be used while staying within the scope and intent of the present invention. Therefore, the present examples and embodiments are to be considered as illustrative and not restrictive, and the invention is not to be limited to the details given herein, but may be modified within the scope of the appended claims.

We claim:

1. A method of transmitting at least one video frame with an overlaid image, comprising the steps of:
a. Capturing said at least one frame of video data separate from said overlaid image at a first rate;
b. Capturing said overlaid image separate from said frame of video data at a second rate;
c. Packetizing said captured frame of video data;
d. Packetizing said overlaid image, wherein said frame video data are in data packets separate from said overlaid image data packets; and
e. Transmitting said separate video data packets and overlaid image data packets.

2. The method of claim 1 wherein the overlaid image is a mouse icon.

3 The method of claim 1 wherein the first rate is equal to the second rate.

4. The method of claim 1 wherein the first rate is less than the second rate.

5. The method of claim 3 wherein the first rate is in the range of 10 to 30 times per second.

6. The method of claim 3 wherein the second rate is in the range of 30 to 60 times per second.

7. The method of claim 1 wherein said captured video data and said captured overlaid image are compressed prior to transmission.

8. The method of claim 1 wherein a copy of said captured overlaid image is locally stored for use in a future transmission.

9. The method of claim 8 wherein said video data packets and overlaid image data packets are captured and transmitted in a first time period.

10. The method of claim 9 wherein a copy of said captured overlaid image captured from a time period prior to said first time period is transmitted with said video data packets and overlaid image data packets captured in said first time period.

11. A method of receiving at least one video frame and an overlaid image, comprising the steps of:
a. Receiving a plurality of video data packets having video data;
b. Storing said video data packets in a buffer array;
c. Receiving a plurality of overlaid image packets having overlaid image data;
d. Storing said overlaid image packets in a memory;
e. Rendering said video data with said overlaid image by accessing a first position in said buffer array, accessing a fifo device associated with said first position in said buffer array, and, based upon data in said fifo device, accessing said memory containing said overlaid image data.

12. The method of claim 11 wherein the overlaid image is a mouse icon.

13. The method of claim 11 wherein said plurality of overlaid image packets comprise overlaid image data to be rendered and overlaid image data to be erased.

14. The method of claim 14 wherein accessing said memory containing said overlaid image data includes accessing overlaid image data to be rendered and overlaid image data to be erased.

15. The method of claim 11 further comprising the step of accessing a second position in said buffer array, accessing a fifo device associated with said second position in said buffer array, and, based upon data in said fifo device, accessing said memory containing said overlaid image.

16. The method of claim 15 wherein accessing said memory containing said overlaid image data includes accessing overlaid image data to be rendered and overlaid image data to be erased.

17. A method of transmitting and receiving at least one video frame with an overlaid image, comprising the steps of:
a. Capturing said at least one frame of video data separate from said overlaid image at a first rate;
b. Capturing said overlaid image separate from said frame of video data at a second rate;
c. Packetizing said captured frame of video data;
d. Packetizing said overlaid image, wherein said frame video data are in data packets separate from said overlaid image data packets;
e. Transmitting said separate video data packets and overlaid image data packets.
f. Receiving said video data packets having video data;
g. Storing said video data packets in a buffer array;
h. Receiving said overlaid image packets having overlaid image data;
i. Storing said overlaid image packets in a memory;
j. Rendering said video data with said overlaid image by accessing a first position in said buffer array, accessing a fifo device associated with said first position in said buffer array, and, based upon data in said fifo device, accessing said memory containing said overlaid image data.

18. The method of claim 17 wherein the overlaid image is a mouse icon.

19. The method of claim 17 wherein the first rate is in the range of 10 to 30 times per second and wherein the second rate is in the range of 30 to 60 times per second.

20. The method of claim 17 wherein said overlaid image packets comprise overlaid image data to be rendered and overlaid image data to be erased and wherein accessing said memory containing said overlaid image data includes accessing overlaid image data to be rendered and overlaid image data to be erased.
